(19) United States
(12) Patent Application Publication
(10) Pub. No.: US 2014/0086319 A1
(43) Pub. Date: Mar. 27, 2014

(54) VIDEO CODING SYSTEM WITH ADAPTIVE UPSAMPLING AND METHOD OF OPERATION THEREOF

(71) Applicant: Sony Corporation, Tokyo (JP)

(72) Inventors: Jun Xu, Sunnyvale, CA (US); Cheung Auyeung, Sunnyvale, CA (US)

(21) Appl. No.: 14/036,688

(22) Filed: Sep. 25, 2013

Related U.S. Application Data
(60) Provisional application No. 61/705,499, filed on Sep. 25, 2012.

(51) Int. Cl. H04N 7/26

(52) U.S. Cl. CPC H04N 19/0089
USPC 375/240.12

(57) ABSTRACT

A video coding system and method of operation includes: a receive bitstream module for receiving a video bitstream and extracting a filter flag from the video bitstream; an upsampling filter module, coupled to the receive bitstream module, for extracting a base layer from the video bitstream, and for forming a prediction for calculating an enhancement layer by upsampling the base layer using an upsampling filter, the upsampling filter configured with upsampling filter coefficients; and a display interface, coupled to the upsampling filter module, for forming a video stream based on the base layer, the enhancement layer, and the filter flag for displaying on a device.

### CROSS-REFERENCE TO RELATED APPLICATION(S)

This application claims the benefit of U.S. Provisional Patent Application Ser. No. 61/705,499 filed Sep. 25, 2012, and the subject matter thereof is incorporated herein by reference thereto.

### TECHNICAL FIELD

The present invention relates generally to video systems, and more particularly to a system for video coding with adaptive upsampling.

### BACKGROUND ART

The deployment of high quality video to smart phones, high definition televisions, automotive information systems, and other video devices with screens has grown tremendously in recent years. The wide variety of information devices supporting video content requires multiple types of video content to be provided to devices with different size, quality, and connectivity capabilities.

Video has evolved from two dimensional single view video to multiview video with high-resolution three dimensional imagery. In order to make the transfer of video more efficient, different video coding and compression schemes have tried to get the best picture from the least amount of data. The Moving Pictures Experts Group (MPEG) developed standards to allow good video quality based on a standardized data sequence and algorithm. The H.264 (MPEG4 Part 10)/Advanced Video Coding design was an improvement in coding efficiency typically by a factor of two over the prior MPEG-2 format. The quality of the video is dependent upon the manipulation and compression of the data in the video. The video can be modified to accommodate the varying bandwidths used to send the video to the display devices with different resolutions and feature sets. However, distributing larger, higher quality video, or more complex video functionality requires additional bandwidth and improved video compression.

Thus, a need still remains for a video coding system that can deliver good picture quality and features across a wide range of device with different sizes, resolutions, and connectivity. In view of the increasing demand for providing video on the growing spectrum of intelligent devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a video coding system including: receiving a video bitstream; extracting a base layer from the video bitstream; extracting a filter flag from the video bitstream; forming a prediction for calculating an enhancement layer by upsampling the base layer using an upsampling filter, the upsampling filter configured with upsampling filter coefficients; and forming a video stream based on the base layer, the enhancement layer, and the filter flag for displaying on a device.

The present invention provides a video coding system including: a receive bitstream module for receiving a video bitstream and extracting a filter flag from the video bitstream; an upsampling filter module, coupled to the receive bitstream module, for extracting a base layer from the video bitstream, and for forming a prediction for calculating an enhancement layer by upsampling the base layer using an upsampling filter, the upsampling filter configured with upsampling filter coefficients; and a display interface, coupled to the upsampling filter module, for forming a video stream based on the base layer, the enhancement layer, and the filter flag for displaying on a device.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a block diagram of a video coding system in an embodiment of the present invention.

FIG. 2 is an example of the video bitstream.

FIG. 3 is an example of a coding tree unit.

FIG. 4 is an example of prediction units.

FIG. 5 is an exemplary block diagram of the video encoder.

FIG. 6 is an example of calculating the enhancement layers.

FIG. 7 is an example of the upsampling module.

FIG. 8 is a control flow for the upsampling process.

FIG. 9 is an example of a sequence parameter set syntax.

FIG. 10 is an example of a picture parameter set syntax.

FIG. 11 is an example of a slice segment syntax.

FIG. 12 is a functional block diagram of the video coding system.

FIG. 13 is a flow chart of a method of operation of the video coding system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

The term “syntax” means the set of elements describing a data structure. The term “module” referred to herein can include software, hardware, or a combination thereof in the present invention in accordance with the context used.

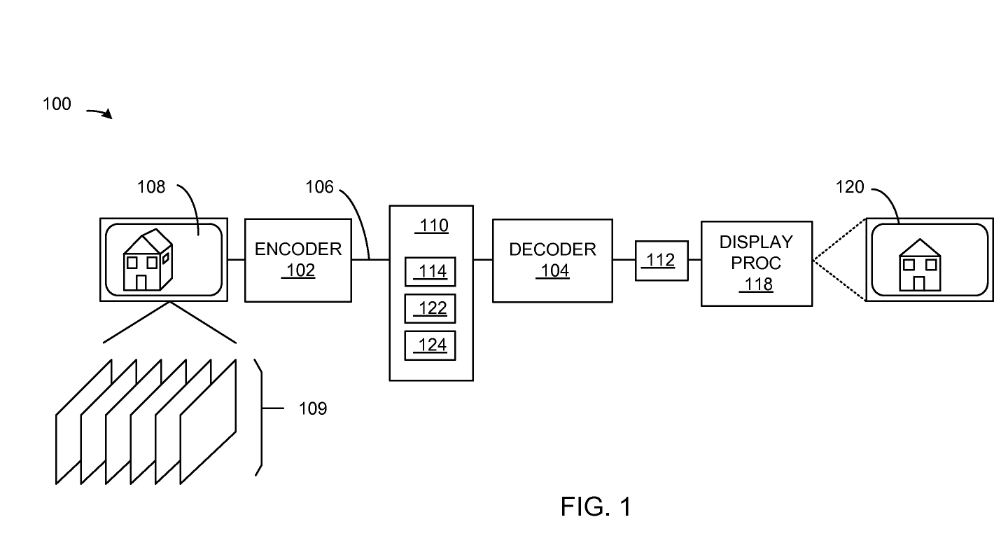

Referring now to FIG. 1, therein is shown a block diagram of a video coding system 100 in an embodiment of the present invention. The video coding system 100 can encode and decode video information. A video encoder 102 can receive a video source 108 and send a video bitstream 110 to a video decoder 104 for decoding and display on a display interface 120.

The video encoder 102 can receive and encode the video source 108. The video encoder 102 is a unit for encoding the video source 108 into a different form. The video source 108 is defined as a digital representation of a scene of objects.

Encoding is defined as computationally modifying the video source 108 to a different form. For example, encoding can compress the video source 108 into the video bitstream 110 to reduce the amount of data needed to transmit the video bitstream 110.

In another example, the video source 108 can be encoded by being compressed, visually enhanced, separated into one or more views, changed in resolution, changed in aspect ratio, or a combination thereof. In another illustrative example, the video source 108 can be encoded according to the High-Efficiency Video Coding (HEVC)/H.265 standard. In yet another illustrative example, the video source 108 can be further encoded to increase spatial scalability.

The video source 108 can include frames 109. The frames 109 are individual images that form the video source 108. For example, the video source 108 can be the digital output of one or more digital video cameras taking 24 of the frames 109 per second.

The video encoder 102 can encode the video source 108 to form the video bitstream 110. The video bitstream 110 is defined a sequence of bits representing information associated with the video source 108. For example, the video bitstream 110 can be a bit sequence representing a compression of the video source 108.

In an illustrative example, the video bitstream 110 can be a serial bitstream sent from the video encoder 102 to the video decoder 104. In another illustrative example, the video bitstream 110 can be a data file stored on a storage device and retrieved for use by the video decoder 104.

The video encoder 102 can receive the video source 108 for a scene in a variety of ways. For example, the video source 108 representing objects in the real-world can be captured with a video camera, multiple cameras, generated with a computer, provided as a file, or a combination thereof.

The video source 108 can include a variety of video features. For example, the video source 108 can include single view video, multiview video, stereoscopic video, or a combination thereof.

The video encoder 102 can encode the video source 108 using a video syntax 114 to generate the video bitstream 110. The video syntax 114 is defined as a set of information elements that describe a coding system for encoding and decoding the video source 108. The video bitstream 110 is compliant with the video syntax 114, such as High-Efficiency Video Coding/H.265, and can include a HEVC video bitstream, an Ultra High Definition video bitstream, or a combination thereof. The video bitstream 110 can include the video syntax 114.

The video bitstream 110 can include information representing the imagery of the video source 108 and the associated control information related to the encoding of the video source 108. For example, the video bitstream 110 can include an occurrence of the video syntax 114 having a representation of the video source 108.

The video encoder 102 can encode the video source 108 to form a base layer 122 and enhancement layers 124. The base layer 122 is a representation of the video source 108. For example, the base layer 122 can include the video source 108 at a different resolution, quality, bit rate, frame rate, or a combination thereof. The base layer 122 can be a lower resolution representation of the video source 108. In another example, the base layer 122 can be a high efficiency video coding (HEVC) representation of the video source 108. In yet another example, the base layer 122 can be a representation of the video source 108 configured for a smart phone display.

The enhancement layers 124 are representations of the video source 108 based on the video source 108 and the base layer 122. The enhancement layers 124 can be higher quality representations of the video source 108 at different resolutions, quality, bit rates, frame rates, or a combination thereof. The enhancement layers 124 can be higher resolution representations of the video source 108 than the base layer 122.

The video coding system 100 can include the video decoder 104 for decoding the video bitstream 110. The video decoder 104 is defined as a unit for receiving the video bitstream 110 and modifying the video bitstream 110 to form a video stream 112.

The video decoder 104 can decode the video bitstream 110 to form the video stream 112 using the video syntax 114. Decoding is defined as computationally modifying the video bitstream 110 to form the video stream 112. For example, decoding can decompress the video bitstream 110 to form the video stream 112 formatted for displaying on the display the display interface 120.

The video stream 112 is defined as a computationally modified version of the video source 108. For example, the video stream 112 can include a modified occurrence of the video source 108 with different resolution. The video stream 112 can include cropped decoded pictures from the video source 108.

The video decoder 104 can form the video stream 112 in a variety of ways. For example, the video decoder 104 can form the video stream 112 from the base layer 122. In another example, the video decoder 104 can form the video stream 112 from the base layer 122 and one or more of the enhancement layers 124.

In a further example, the video stream 112 can have a different aspect ratio, a different frame rate, different stereoscopic views, different view order, or a combination thereof than the video source 108. The video stream 112 can have different visual properties including different color parameters, color planes, contrast, hue, or a combination thereof.

The video coding system 100 can include a display processor 118. The display processor 118 can receive the video stream 112 from the video decoder 104 for display on the display interface 120. The display interface 120 is a unit that can present a visual representation of the video stream 112.

For example, the display interface 120 can include a smart phone display, a digital projector, a DVD player display, or a combination thereof. Although the video coding system 100 shows the video decoder 104, the display processor 118, and the display interface 120 as individual units, it is understood that the video decoder 104 can include the display processor 118 and the display interface 120.

The video encoder 102 can send the video bitstream 110 to the video decoder 104 in a variety of ways. For example, the video encoder 102 can send the video bitstream 110 to the video decoder 104 over a communication path 106. In another example, the video encoder 102 can send the video bitstream 110 as a data file on a storage device. The video decoder 104 can access the data file to receive the video bitstream 110.

The communication path 106 can be a variety of networks suitable for data transfer. For example, the communication path 106 can include wireless communication, wired communication, optical, infrared, or the combination thereof. Satellite communication, cellular communication, terrestrial communication, Bluetooth, Infrared Data Association standard (IrDA), wireless fidelity (WiFi), and worldwide interoperability for microwave access (WiMAX) are examples of wireless communication that can be included in the communication path 106. Ethernet, digital subscriber line (DSL), fiber to the home (FTTH), digital television, and plain old telephone service (POTS) are examples of wired communication that can be included in the communication path 106.

The video coding system 100 can employ a variety of video coding syntax structures. For example, the video coding system 100 can encode and decode video information using High Efficiency Video Coding/H.265 (HEVC), scalable extensions for HEVC(SHVC), or other video coding syntax structures. The video coding syntaxes are described in the following documents that are incorporated by reference in their entirety:
J. Chen, J. Boyce, Y. Ye, M. Hannuksela, “SHVC Test Model 1 (SHM 1)”, JCTVC-L1007 v3, January 2013, (Geneva)
B. Bross, W. Han, J Ohm, G. Sullivan, Y. Wang, T. Wiegand, “High-Efficiency Video Coding (HEVC) text specification draft 10”, JCTVC-L1003 v34, January 2013 (Geneva).

The video encoder 102 and the video decoder 104 can be implemented in a variety of ways. For example, the video encoder 102 and the video decoder 104 can be implemented using hardware, software, or a combination thereof. For example, the video encoder 102 can be implemented with custom circuitry, a digital signal processor, microprocessor, or a combination thereof. In another example, the video decoder 104 can be implemented with custom circuitry, a digital signal processor, microprocessor, or a combination thereof.

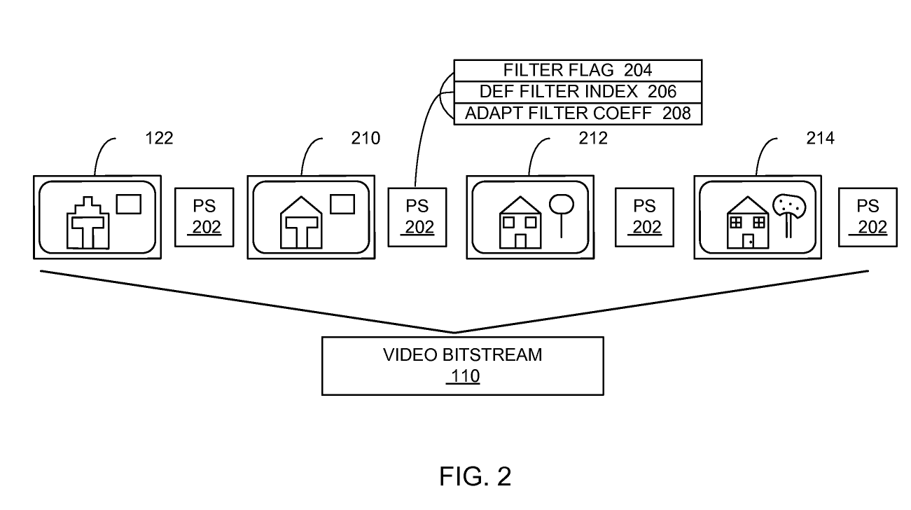

Referring now to FIG. 2 therein is shown an example of the video bitstream 110. The video bitstream 110 includes an encoded occurrence of the video source 108 of FIG. 1 and can be decoded to form the video stream 112 of FIG. 1 for display on the display interface 120 of FIG. 1. The video bitstream 110 can include the base layer 122 and the enhancement layers 124 based on the video source 108.

The video bitstream 110 can include one of the frames 109 of FIG. 1 of the base layer 122 followed by a parameter set 202 associated with the enhancement layer 124. The parameter set 202 can include a filter flag 204 and a default filter index 206.

The filter flag 204 is an indicator for whether the associated one of the frames 109 of the base layer 122 should be decoded using a default filter or with an adaptive filter. If the filter flag 204 has a value of 1, then the default filter is selected. The default filter index 206 is an indicator for selecting one of several pre-determined default filters for decoding the video bitstream 110.

The video bitstream 110 can include the frames 109 of the enhancement layers 124. For example, the enhancement layers 124 can include the frames 109 from a first enhancement layer 210, a second enhancement layer 212, and a third enhancement layer 214. Each of the frames 109 of the enhancement layers 124 can be followed by the parameter set 202 associated with one of the enhancement layers 124.

The video bitstream 110 can include adaptive filter coefficients 208. The adaptive filter coefficients 208 are values for modifying a filter for forming the enhancement layers 124 from the base layer 122. The adaptive filter coefficients 208 are based on the base layer 122 and provide local context information. The adaptive filter coefficients 208 can be formed for each of the frames 109 of the base layer 122.

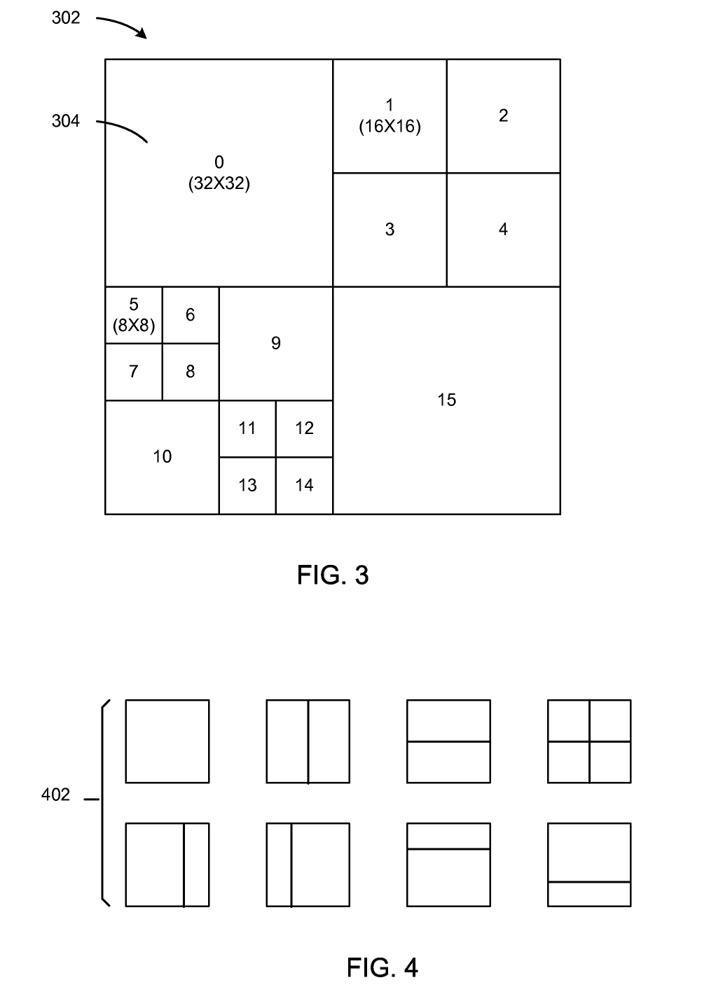

Referring now to FIG. 3, therein is shown an example of a coding tree unit 302. The coding tree unit 302 is a basic unit of video coding.

The video source 108 of FIG. 1 can include frames 109 of FIG. 1. Each of the frames 109 can be encoded into the coding tree unit 302.

The coding tree unit 302 can be subdivided into coding units 304 using a quadtree structure. The quadtree structure is a tree data structure in which each internal mode has exactly four children. The quadtree structure can partition a two dimensional space by recursively subdividing the space into four quadrants.

The frames 109 of the video source 108 can be subdivided into the coding units 304. The coding units 304 are square regions that make up one of the frames 109 of the video source 108.

The coding units 304 can be a variety of sizes. For example, the coding units 304 can be up to 64×64 pixels in size. Each of the coding units 304 can be recursively subdivided into four more of the coding units 304. In another example, the coding units 304 can include the coding units 304 having 64×64 pixels, 32×32 pixels, 16×16 pixels, or 8×8 pixels.

Referring now to FIG. 4, therein is shown an example of prediction units 402. The prediction units 402 are regions within the coding units 304 of FIG. 3. The contents of the prediction units 402 can be calculated based on the content of other adjacent regions of pixels.

Each of the prediction units 402 can be calculated in a variety of ways. For example, the prediction units 402 can be calculated using intra-prediction or inter-prediction.

The prediction units 402 calculated using intra-prediction can include content based on neighboring regions. For example, the content of the prediction units 402 can be calculated using an average value, by fitting a plan surface to one of the prediction units 402, direction prediction extrapolated from neighboring regions, or a combination thereof.

The prediction units 402 calculated using inter-prediction can include content based on image data from the frames 109 of FIG. 1 that are nearby. For example, the content of the prediction units 402 can include content calculated using previous frames or later frames, content based on motion compensated predictions, average values from multiple frames, or a combination thereof.

The prediction units 402 can be formed by partitioning one of the coding units 304 in one of eight partition modes. The coding units 304 can include one, two, or four prediction units 402. The prediction units 402 can be rectangular or square.

For example, the prediction units 402 can be represented by mnemonics 2N×2N, 2N×N, N×2N, N×N, 2N×nU, 2N×nD, nL×2N, and nR×2N. Uppercase “N” can represent half the length of one of the coding units 304. Lowercase “n” can represent one quarter of the length of one of the coding units 304. Uppercase “R” and “L” can represent right or left respectively. Uppercase “U” and “D” can represent up and down respectively.

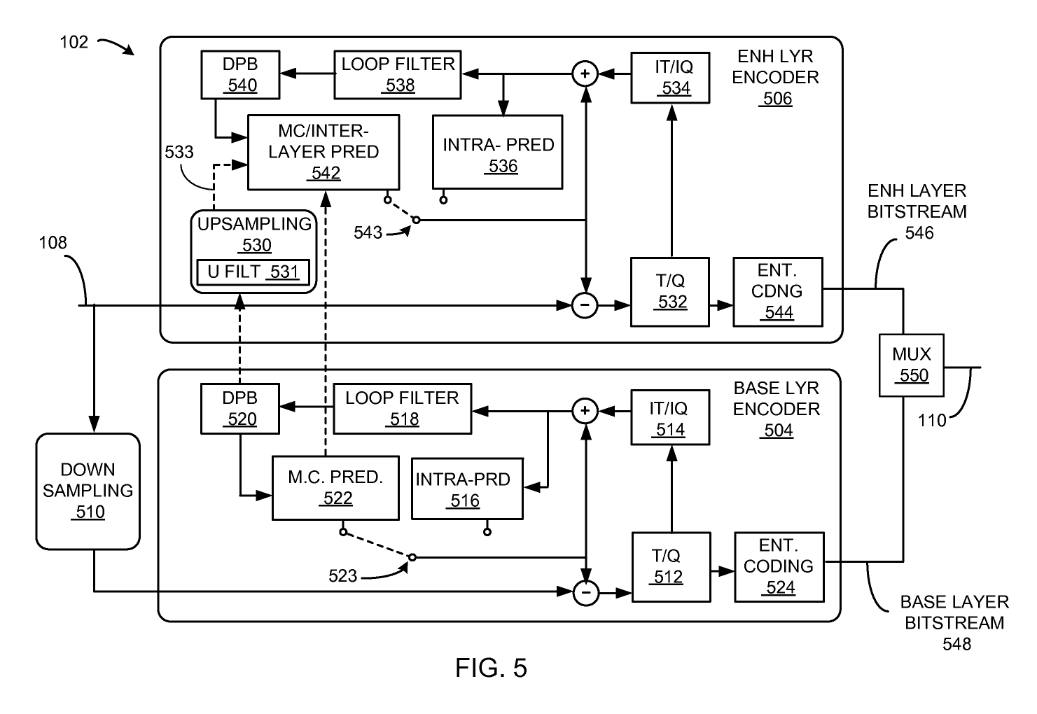

Referring now to FIG. 5 therein is shown an exemplary block diagram of the video encoder 102. The video encoder 102 can form the base layer 122 of FIG. 1 and the enhancement layers 124 of FIG. 1 based on the video source 108.

The video encoder 102 can encode the video source 108 to form the video bitstream 110. For example, the video encoder 102 can be used to form a base layer bitstream 548 and an enhancement layer bitstream 546 that can be multiplexed together to form the video bitstream 110.

The video encoder 102 can receive the video source 108 that has been processed by a downsampling module 510. The downsampling module 510 can downsample the video source 108 to a lower size or resolution. For example, the downsampling module 510 can provide a base layer encoder 504 with the video source 108 downsampled to fit on a table computer, smart phone, or other video display apparatus.

The video coding system 100 of FIG. 1 can include the video decoder 104 of FIG. 1 for decoding the video bitstream 110 provided by the video encoder 102. The video decoder 104 can have a complementary structure to the video encoder 102 for forming the video stream 112 of FIG. 1 based on the base layer 122 and the enhancement layers 124 formed by the video decoder. It is understood that the video decoder 104 can include similar modules to the video encoder 102.

The video encoder 102 can include the base layer encoder 504 and an enhancement layer encoder 506. Although the video encoder 102 shown depicts a single one of the enhancement layer encoder 506, it is understood that the video encoder 102 can include one of the enhancement layer encoder 506 for each of the enhancement layers 124.

The base layer encoder 504 can be implemented in a variety of ways. For example, the base layer encoder 504 can be a HEVC/Advanced Video coding (AVC) encoder.

The base layer encoder 504 can receive the video source 108 and form the base layer 122. The video source 108 can be at the original resolution or can be downsampled to reduce the resolution or quality.

The base layer encoder 504 can include a transformation and quantization module 512 for performing transformation operations, scaling operations, quantization operations, or a combination thereof. The transformation and quantization module 512 can receive the video source 108 and intermediate video content and pass additional intermediate video content to an entropy coding module 524 for forming the video bitstream 110, including the enhancement layer bitstream 546.

The intermediate video content is partially processed video information used by the base layer encoder 504 and the enhancement layer encoder 506. The intermediate video content can include portions of frames, motion elements, regions, color maps, tables, or a combination thereof.

The base layer encoder 504 can include the inverse transformation and inverse quantization module 514. The inverse transform and inverse quantization module 514 can perform inverse transformation and inverse quantization operations on the intermediate video content received from the transformation and quantization module 512.

The base layer encoder 504 can include an intra-picture prediction module 516. The intra-picture prediction module 516 can calculate portions of the intermediate video content based on adjacent regions within one of the frames 109 of FIG. 1. The intra-picture prediction module 516 can receive intermediate video content from the inverse transformation and inverse quantization module 514.

The base layer encoder 504 can include a loop filter module 518 for processing the intermediate video content based on loop levels with the base layer encoder 504. The loop filter module 518 can process and send the intermediate video content to a digital picture buffer module 520. The loop filter module 518 can process reconstructed samples or portions of the base layer 122 before writing into the decoded picture buffer 520/540. The loop filter module 518 can improve the reconstructed picture quality for better temporal prediction for future pictures.

The base layer encoder 504 can include the digital picture buffer module 520. The digital picture buffer module 520 can include memory storage for holding intermediate video content. The digital picture buffer module 520 can receive the intermediate video content from the loop filter module 518 and buffer the information for future loop iterations. The digital picture buffer module 520 can send the intermediate video content to a motion compensation prediction module 522.

The base layer encoder 504 can include the motion compensation prediction module 522. The motion compensation prediction module 522 calculate motion compensation and motion vector information based on multiple frames from the video source 108 and intermediate video content.

The base layer encoder 504 can selectively loop the output of the intra-picture prediction module 516 or the motion compensation prediction module 522 back to the transformation and quantization module 512 using a mode selector 523. The mode selector 523 can select the output of the intra-picture prediction module 516 or the motion compensation prediction module 522 for sending to the transformation and quantization module 512. The selection of which module to select is based on the content of the video source 108.

The base layer encoder 504 can include the entropy coding module 524. The entropy coding module 524 can encode the residual portions of the video source 108 to form a portion of the base layer 122. The entropy coding module 524 can output the base layer bitstream 548. The base layer bitstream 548 is a representation of the base layer 122.

The video encoder 102 can include the enhancement layer encoder 506. The enhancement layer encoder 506 can calculate the enhancement layers 124 based on the video source 108 and the base layer 122.

The enhancement layer encoder 506 has a similar configuration as the base layer encoder 504. The enhancement layer encoder 506 can include a transformation and quantization module 532, an inverse transformation and inverse quantization module 534, an intra-picture prediction module 536, a loop filter module 538, a digital picture buffer module 540, and an entropy coding module 544. Each of the modules performs in a manner substantially similar to the modules in the base layer encoder 504 as described above.

The enhancement layer encoder 506 can be implemented in a variety of ways. For example, the enhancement layer encoder 506 can be a scalability extension of HEVC encoder.

The enhancement layer encoder 506 can receive intermediate video content from the base layer 122 that can be upsampled to form the enhancement layers 124. The enhancement layer encoder 506 can receive intermediate video content from the motion compensation prediction module 522 of the base layer encoder 504 and the digital picture buffer module 540 of the base layer encoder 504.

The enhancement layer encoder 506 can include an upsampling module 530. The upsampling module 530 can receive intermediate video content from the base layer encoder 504. The upsampling module 530 can upsample the intermediate video content from the base layer 122 to send a prediction 533 to a motion compensation and inter-layer prediction module 542 for forming portions of the enhancement layers 124.

The prediction 533 is a portion of an image of the enhancement layer formed from a portion of the base layer 122. The prediction 533 can include image elements such as coding units 304 of FIG. 3, prediction units 402 of FIG. 4, frames 109 of FIG. 1, or a combination thereof.

The upsampling module 530 can implement an upsampling filter 531. The upsampling filter 531 is an interpolation filter for forming the prediction 533 for the enhancement layers 124. For example, the upsampling filter 531 can be a least mean squares filter, a discrete cosine transform filter, an interpolation filter as described in the HEVC/H.265 specification, or other similar interpolation filter.

The upsampling module 530 can be configured to provide a variety of filters. For example, the upsampling module 530 can support one or more types of the default filter, an adaptive filter, other filter types, or a combination thereof.

The motion compensation and inter-layer prediction module 542 can form potions of the enhancement layers 124 based on the multiple frames of video information. Video elements common to multiple frames can be identified within each of the frames and coded to reduce the volume of data required to represent the video elements within the video bitstream 110.

The enhancement layer encoder 506 can receive scaled motion information from the motion compensation prediction module 522 of the base layer encoder 504. The scaled motion information can be received by the motion compensation prediction module 522 of the enhancement layer encoder 506.

The enhancement layer encoder 506 can selectively loop the output of the intra-picture prediction module 536 or the motion compensation and inter-layer prediction module 542 back to the transformation and quantization module 532 using the mode selector 543. The mode selector 543 can select the output of the intra-picture prediction module 536 or the motion compensation and inter-layer prediction module 542 for sending to the transformation and quantization module 532. The selection of which module to select is based on the content of the video source 108.

The entropy coding module 544 of the enhancement layer encoder 506 can form the enhancement layer bitstream 546 for each of the enhancement layers 124. The base layer bitstream 548 and the enhancement layer bitstream 546 can be combined in a multiplexer 550 to form the video bitstream 110.

It has been discovered the encoding the video source 108 with the video encoder 102 to form the base layer 122 and the enhancement layers 124 to form the video bitstream 110 increases the level of video compression and increases operation flexibility. Providing the base layer 122 and the enhancement layers 124 in the video bitstream 110 allows the formation of the video stream 112 at different resolutions at a lower bandwidth by partitions the compressed video information.

It has been discovered that the video encoder 102 having the base layer encoder 504 and the enhancement layer encoder 506 can increase performance and flexibility. By encoding the base layer 122 and the enhancement layers 124, the video coding system 100 can provide different resolutions and image sizes to support different video display systems.

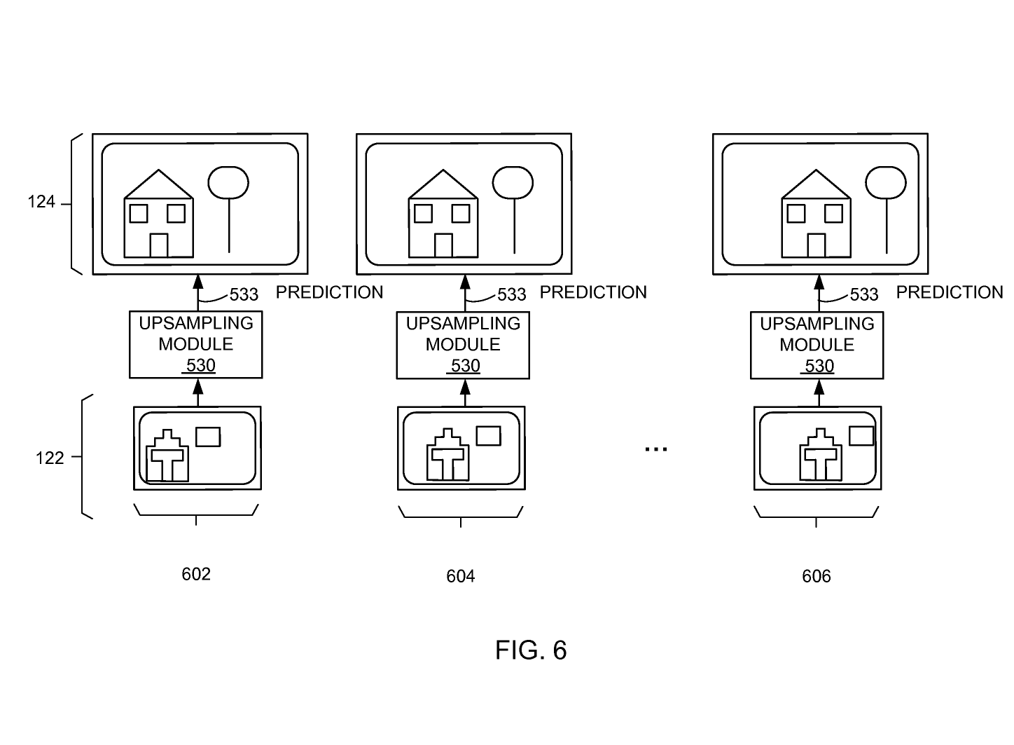

Referring now to FIG. 6 therein is shown an example of calculating the enhancement layers 124. Each of the enhancement layers 124 can be calculated based on the prediction 533 upsampled from the base layer 122.

In an illustrative example, the video bitstream 110 of FIG. 1 can have a series of frames 109 of FIG. 1 of the base layer 122 including a first frame 602, a second frame 604, and an nth frame 606. The video decoder 104 of FIG. 1 can calculate the content of the corresponding one of the frames 109 of one of the enhancement layers 124 by upsampling the content of the base layer 122 to form the prediction 533.

Upsampling is the process of increasing sampling rate of a signal. Upsampling for video coding is defined as generating additional video information for increasing the resolution or size of a video image. Upsampling can include interpolating new pixels based on an original image.

Upsampling can be performed by an integer factor of size and resolution or by a rational fraction factor. In integer factor upsampling, such as 2× upsampling, there are “n×n” pixels in an enhanced image for each of the original pixels in the base image. Each of the new pixels is based on the corresponding pixel I the base image.

In rational fraction factor upsampling, such as 1.5× upsampling, the base image can be upsampled by the denominator factor and downsampled by the numerators factor to form the fractional upsampling result. For example, to achieve 1.5× upsampling, the base layer 122 can be upsampled by an integer factor of 3 and then downsampled at an integer factor of 2 to result in an enhanced image having 1.5× upsampling.

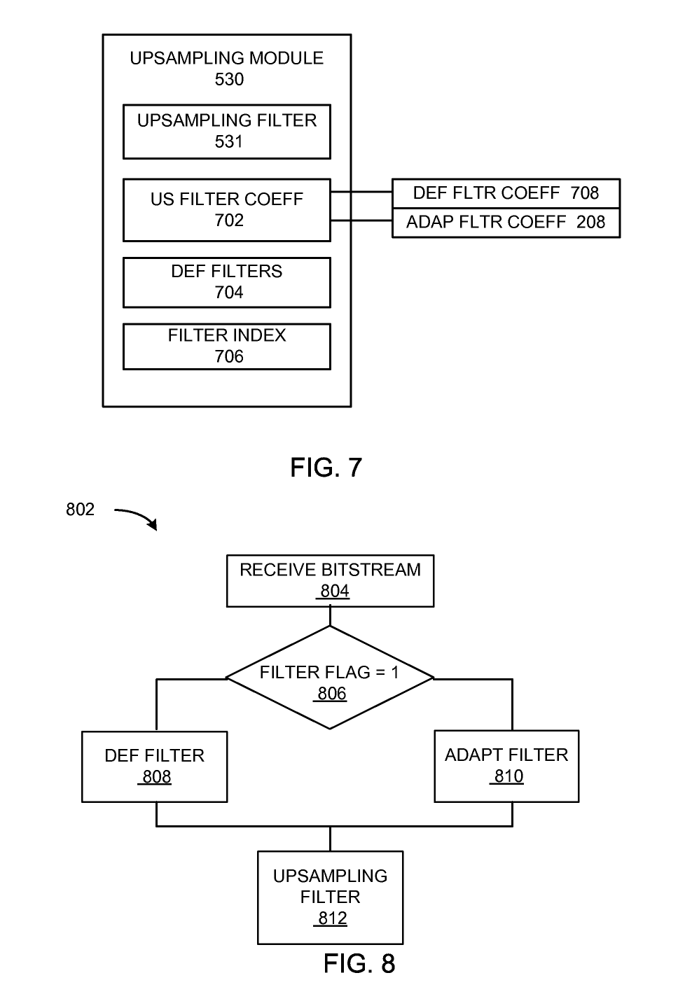

Referring now to FIG. 7, therein is shown an example of the upsampling module 530. The upsampling module 530 can create the enhancement layers 124 of FIG. 1 based on the prediction 533 of FIG. 4 formed by upsampling the base layer 122 of FIG. 1 with the upsampling filter 531 configured with an upsampling filter coefficients 702.

The upsampling module 530 can include the upsampling filter 531. The upsampling filter 531 can include default filters 704, the adaptive filter, or a combination thereof.

The upsampling filter 531 can be configured with the upsampling filter coefficients 702. The upsampling filter coefficients 702 can include default filter coefficients 708, the adaptive filter coefficients 208, or a combination thereof. For example, the upsampling filter coefficients 702 can be assigned the values of the adaptive filter coefficients 208.

The upsampling module 530 can include the default filters 704 and the default filter coefficients 708. The default filters 704 and the default filter coefficients 708 are stored local to the upsampling module 530. The default filter coefficients 708 are not included in the video bitstream 110.

The upsampling module 530 can include a filter index 706 to identify and select one of the default filters 704 and one of the default filter coefficients 708. The upsampling filter 531 can be assigned to one of the default filters 704. The upsampling filter coefficients 702 can be assigned the values of one of the default filter coefficients 708.

Referring now to FIG. 8 therein is shown a control flow for an upsampling process 802. The adaptive upsampling process 802 can determine the type of upsampling to be used to decode the video bitstream 110 of FIG. 1.

The adaptive upsampling process 802 can receive the base layer 122 of FIG. 1 from the video bitstream 110 and calculate one of the enhancement layers 124 of FIG. 1 based on the prediction 533 of FIG. 5 formed by upsampling the base layer 122. The adaptive upsampling process 802 can include a receive bitstream module 804, a detect filter flag module 806, a default filter module 808, an adaptive filter module 810, and the upsampling module 530 of FIG. 5.

The receive bitstream module 804 can receive the video bitstream 110 and extract the base layer 122 information and the parameter set 202 of FIG. 2. The base layer 122 can include the content of the video stream 112 of FIG. 1 at a minimum resolution or quality. The base layer 122 can include content based on each of the frames 109 of FIG. 1 of the video source 108 of FIG. 1.

The parameter set 202 is a group of data parameters associated with the video bitstream 110. The parameter set 202 can include information about encoding and decoding the video content. For example, the parameter set 202 can include control information, compression information, context information, or a combination thereof.

The parameter set 202 can include the filter flag 204 of FIG. 2. The filter flag 204 is an indicator for use of the upsampling process during decoding. The filter flag 204 can be associated with one of the frames 109 of the video bitstream 110. The filter flag 204 can determine if the adaptive upsampling process 802 can perform upsampling with default upsampling filter coefficients 702 of FIG. 7 or with a set of the adaptive filter coefficients 208 of FIG. 2.

The parameter set can include the default filter index 206 of FIG. 2. The default filter index 206 can indicate which of the default filters should be selected. After completion, the receive bitstream module 804 can pass control to the detect filter flag module 806.

The detect filter flag module 806 can detect the value of the filter flag 204 and pass the control flow to the appropriate module. The detect filter flag module 806 can perform a check on the value of the filter flag 204 and if the filter flag 204 is TRUE or “1”, then the adaptive upsampling process 802 can pass the control flow to the default filter module 808. If the filter flag 204 is FALSE or “0”, then the control flow can pass to the adaptive filter module 810.

The default filter module 808 can determine which of the default filters 704 of FIG. 7 is selected to be assigned to the upsampling filter 531 of FIG. 5. The selection can be based on the filter flag 204 and the default filter index 206. The video coding system 100 of FIG. 1 can include one or more of the default filters 704 and the default filter coefficients 708.

The default filter index 206 can have a value to select one of the default filters 704 and the default filter coefficients 708. The upsampling filter 531 can be assigned to the selected one of the default filters 704 indicated by the default filter index 206. The selected one of the default filter coefficients 708 can be assigned to the upsampling filter coefficients 702.

The default filter module 808 can implement different configurations of the default filters. For example, the default filter module 808 can implement a single one of the default filters 704 and a single set of the default filter coefficients 708.

In another example, the default filter module 808 can implement four of the default filters 704 and include four of the default filter coefficients 708. One of the default filters 704 and one of the default filter coefficients 708 can be selected based on the default filter index 206.

The default filter module 808 can configure the video decoder by assigning the upsampling filter 531 to the selected one of the default filters 704 and assigning the upsampling filter coefficients 702 to the selected one of the default filter coefficients. After the default filter module 808 has completed, the control flow can pass to the upsampling module 530.

The adaptive filter module 810 can assign the upsampling filter 531 to the adaptive filter and assign the upsampling filter coefficients 702 to the adaptive filter coefficients 208. The adaptive filter can be one of the default filters 704 or a separate adaptive filter.

The adaptive filter module 810 can extract the adaptive filter coefficients 208 from the parameter set 202 of the video bitstream 110. The adaptive filter coefficients 208 are values to customize the behavior of the upsampling filter 531. The adaptive filter coefficients 208 can be used to predict the content of one of the enhancement layers 124 based on the content of the base layer 122.

For example, the adaptive filter coefficients 208 can be used in the upsampling process to predict the contents of one of the prediction units 402 of one of the enhancement layers 124. The upsampling process can predict the content of one of the frames 109 of the base layer 122 and form the frames 109 of the enhancement layers 124 based on a scaling factor, such as by a factor of 16.

The adaptive filter coefficients 208 and the filter flag 204 can be associated with the base layer 122 in the video bitstream 110. For example, each of the frames 109 of the base layer 122 can be associated with the parameter set 202 having the filter flag 204 and the adaptive filter coefficients 208. Once the adaptive filter module 810 has completed, the control flow can pass to an upsampling filter module 812.

The upsampling filter module 812 can apply the upsampling filter coefficients 702 to the upsampling filter 531 and calculate the prediction 533 for one of frames 109 of one of the enhancement layers 124. The upsampling filter 531 can predict the content of one of the enhancement layers 124 based on the content of the base layer 122 and the upsampling filter coefficients 702.

The upsampling filter module 812 can calculate different portions of the frames 109 of the enhancement layers 124 depending on how the base layer 122 is encoded. For example, the upsampling filter module 812 can calculate portions including the prediction units 402 of FIG. 4, the coding tree unit 302 of FIG. 3, the coding units 304 of FIG. 3, or a combination thereof.

It has been discovered that supplementing the video bitstream 110 with the filter flag 204 provide decoding performance improvement. Providing individual upsampling control over the frames 109 allows fine grained control over the quality and computing time required to code and decode the video source 108 to and from the video bitstream 110.

It has been discovered that providing the adaptive filter coefficients 208 for configuring the upsampling filter increases the quality of the video stream 112. The adaptive filter coefficients 208 used with the adaptive upsampling filter module 812 can form the enhancement layers 124 with higher image quality by utilizing the adaptive filter coefficients 208 extracted from the video bitstream 110 as the parameter set 202 associated with one of the frames 109 of the video source 108.

It has been discovered that providing the default filters 704 and the default filter index 706 provides improved performance and flexibility. Allowing the default filter module 808 to select between one of several of the default filters 704 using the default filter index 706 provides a better match of the default filters 704 to the content of the video source 108 and reduce the overall volume of data.

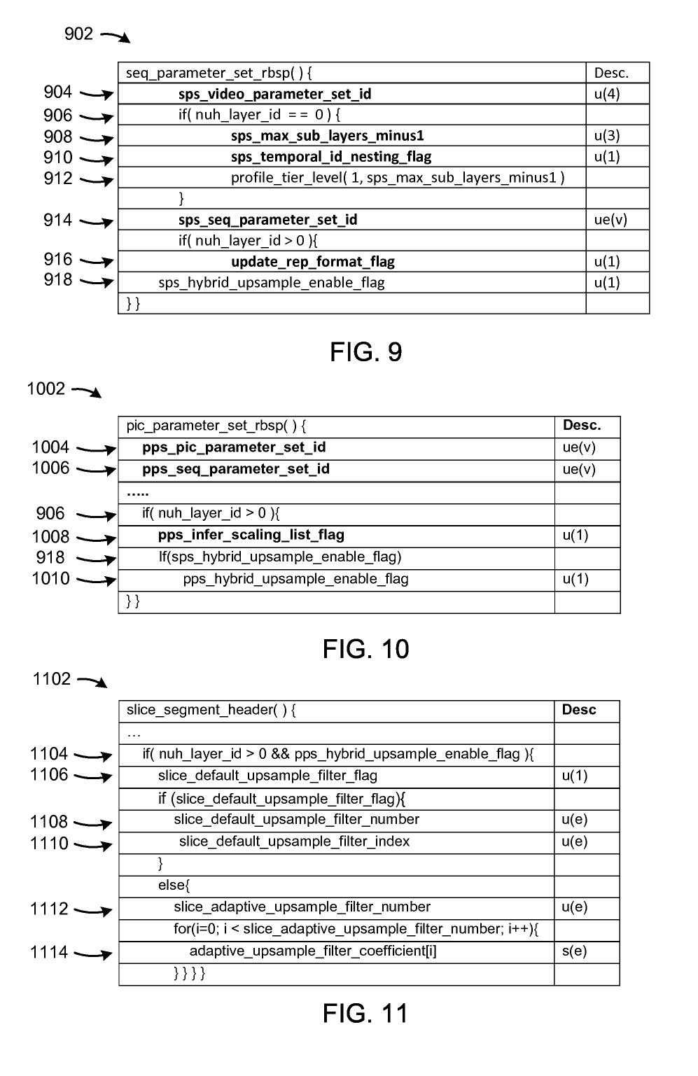

Referring now to FIG. 9, therein is shown an example of a sequence parameter set syntax 902. The sequence parameter set syntax 902 (SPS syntax) can describe the parameters associated with a sequence parameter set.

The sequence parameter set syntax 902 includes elements as described in the table of FIG. 9. The elements of the sequence parameter set syntax 902 are arranged in a hierarchical structure as shown in the table of FIG. 9. The sequence parameter set syntax 902 can be included in the video bitstream 110 of FIG. 1 with each element provided in the order produced.

The sequence parameter set syntax 902 can include a video parameter set id 904, such as a sps_video_parameter_set_id element. The video parameter set id 904 is an identifier for the active video parameter set.

The sequence parameter set syntax 902 can include a nuh layer id 906, such as a nuh_layer_id element. The nuh layer id 906 can represent the layer id of a network abstraction layer unit header.

If the nuh layer id 906 has a value of 0, then the sequence parameter set syntax 902 can include a max sub layers count 908, a temporal id nesting flag 910, and a profile tier level structure 912. If the nuh layer id 906 does not have a value of 0, then the elements are omitted.

The max sub layers count 908, such as a sps_max_sub_layers_minus1 element, can specify the maximum number of temporal sub-layers that may be present in each coded video sequence. The temporal id nesting flag 910, such as a sps_temporal_id_nesting_flag_element, can specify whether inter prediction is additionally restricted for coded video sequences. The profile tier level structure 912, such as the profile_tier_level structure, can represent sub-layer information.

The sequence parameter set syntax 902 can include a SPS sequence parameter set identifier 914, such as a sps_seq_parameter_set_id element. The SPS sequence parameter set identifier 914 can identify the sequence parameter set.

If the nuh layer id 906 is greater than 0, then the sequence parameter set syntax 902 can include an update rep format flag 916 and a SPS hybrid upsample enable flag 918. The update rep format flag 916, such as an update rep format flag element, can indicate the status of the update rep format including syntax elements for picture size, bit depth, chroma information, and luma information.

The SPS hybrid upsample enable flag 918, such as a sps_hybrid_upsample_enable_flag element, can enable the hybrid upsampling filter selection. If the SPS hybrid upsample enable flag 918 is equal to 1, then the hybrid upsample filter selections is enabled in the sequence. If the SPS hybrid upsample enable flag 918 is equal to 0, then the upsampling filter is default filter set with index equal to 0. For example, the filter flag 204 of FIG. 2 can be implemented with the SPS hybrid upsample enable flag 918.

Referring now to FIG. 10, therein is shown an example of a picture parameter set syntax 1002. The picture parameter set syntax 1002 can describe the parameters associated with a sequence parameter set.

The picture parameter set syntax 1002 includes elements as described in the table of FIG. 10. The elements of the picture parameter set syntax 1002 are arranged in a hierarchical structure as shown in the table of FIG. 10. The picture parameter set syntax 1002 can be included in the video bitstream 110 of FIG. 1 with each element provided in the order produced.

The picture parameter set syntax 1002 can include a picture parameter set id 1004, such as a pps_pic_parameter_set_id element. The picture parameter set id 1004 can identify the picture parameter set.

The picture parameter set syntax 1002 can include a picture sequence parameter set id 1006, such as a pps_seq_parameter_set_id element. The picture sequence parameter set id 1006 can identify the picture sequence parameter set.

The picture parameter set syntax 1002 can include the nuh layer id 906 of FIG. 9. If the nuh layer id 906 is greater than 0, then the picture parameter set syntax 1002 can include an infer scaling list flag 1008, such as a pps_infer_scaling_list_flag element. The infer scaling list flag 1008 can specify how to interpret the scaling list data syntax structure.

If the SPS hybrid upsample enable flag 918 of FIG. 9 indicates true, then the picture parameter set syntax 1002 can include a picture hybrid upsample enable flag 1010. The picture hybrid upsample enable flag 1010 controls the hybrid upsampling filter selection in the picture set. If the picture hybrid upsample enable flag 1010 has a value of 1, then the hybrid upsampling filter selections in the picture set is enabled. If the picture hybrid upsample enable flag 1010 has a value equal to 0, then the upsampling filter specifies the default filter set with index equal to 0. For example, the filter flag 204 of FIG. 2 can be implemented with the picture hybrid upsample enable flag 1010.

Referring now to FIG. 11, therein is shown an example of a slice segment syntax 1102. The slice segment syntax 1102 can describe the parameters associated with a slice segment.

The frames 109 of FIG. 1 of the video source 108 of FIG. 1 can be partitioned into slices. Each of the slices can be an integer number of coding tree blocks ordered consecutively.

The slice segment syntax 1102 includes elements as described in the table of FIG. 11. The elements of the slice segment syntax 1102 are arranged in a hierarchical structure as shown in the table of FIG. 11. The slice segment syntax 1102 can be included in the video bitstream 110 of FIG. 1 with each element provided in the order produced.

The picture parameter set syntax 1002 can include the nuh layer id 906 of FIG. 1 and a pps hybrid upsample enable flag 1104. If the nuh layer id 906 is greater than 0 and the pps hybrid upsample enable flag 1104 is true, then the slice segment syntax 1102 can include the slice default upsample filter flag 1106, such as a slice default upsample filter flag element.

The slice default upsample filter flag 1106 can represent the selection of the upsampling filter within default filter sets. The slice default upsample filter flag 1106 having a value equal to 1 specifies the upsampling filter 531 of FIG. 5 is selected within default filter sets. The slice default upsample filter flag 1106 having a value equal to 0 specifies that upsampling filter is adaptive filter.

If the slice default upsample filter flag 1106 has a value of 1, then the slice segment syntax 1102 can include a slice default upsample filter number 1108 and a slice default upsample filter index 1110. The slice default upsample filter number 1108, such as a slice default upsample filter number element, specifies the number of default filter sets. When a slice default upsample filter number 1108 is not present, the number of default filter sets is inferred to be equal to 0. For example, the default filters 704 of FIG. 7 can be implemented based on the slice default upsample filter number 1108.

The slice default upsample filter index 1110, such as a slice_default_upsample_filter_index element, specifies the index of default upsample filter set. The slice default upsample filter index 1110 takes values between 0 and the slice default upsample filter number 1108. When slice default upsample filter index 1110 is not present, it is inferred to be equal to 0. For example, the default filter index 206 of FIG. 2 can be implemented with the slice default upsample filter index 1110.

If the nuh layer id 906 is not greater than 0 or the Pps hybrid upsample enable flag 1104 is false, then the slice segment syntax 1102 can include a slice adaptive upsample filter number 1112, such as a slice_adaptive_upsample_filter_number element, and a set of adaptive upsample filter coefficients 1114, such as adaptive_upsample_filter_coefficient elements.

The slice adaptive upsample filter number 1112 specifies the number of adaptive filter coefficients 208 of FIG. 2. When the slice adaptive upsample filter number 1112 is not present, it is inferred to be equal to 0.

The adaptive upsample filter coefficients 1114 provide the value of each of the adaptive filter coefficients. The adaptive upsample filter coefficients 1114 can be indexed up to the slice adaptive upsample filter number 1112. When the adaptive upsample filter coefficients 1114 are not present, the value is inferred to be equal to 0. For example, the adaptive filter coefficients 208 can be implemented with the adaptive upsample filter coefficients 1114.

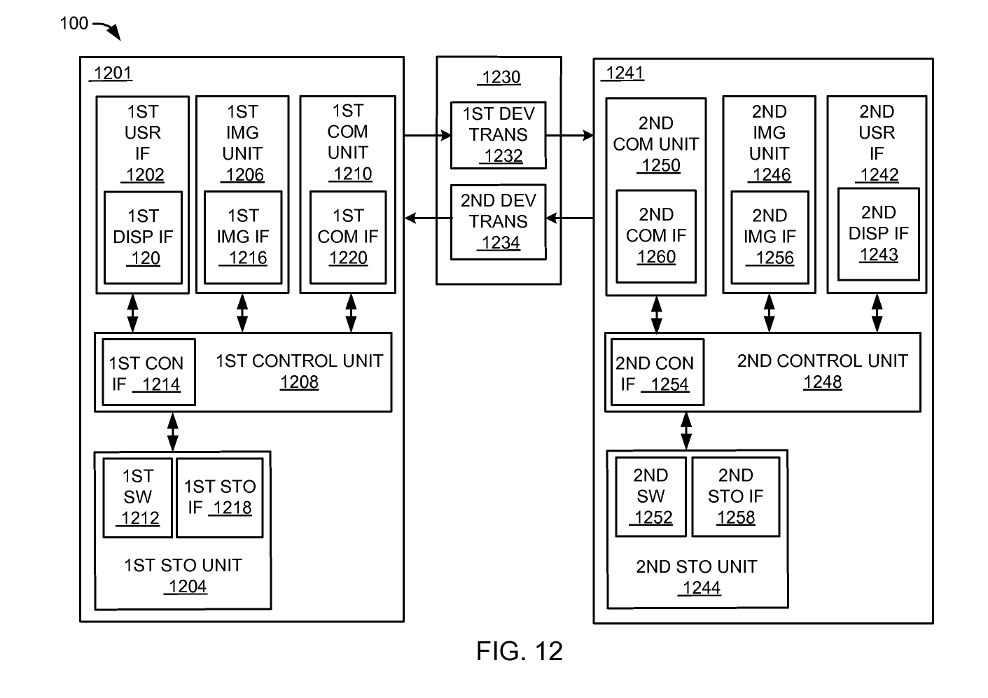

Referring now to FIG. 12, therein is shown a functional block diagram of the video coding system 100. The video coding system 100 can include a first device 1201, a second device 1241 and a communication link 1230.

The video coding system 100 can be implemented using the first device 1201, the second device 1241, and the communication link 1230. For example, the first device 1201 can implement the video encoder 102 of FIG. 1, the second device 1241 can implement the video decoder 104 of FIG. 1, and the communication link 1230 can implement the communication path 106 of FIG. 1. However, it is understood that the video coding system 100 can be implemented in a variety of ways and the functionality of the video encoder 102, the video decoder 104, and the communication path 106 can be partitioned differently over the first device 1201, the second device 1241, and the communication link 1230.

The first device 1201 can communicate with the second device 1241 over the communication link 1230. The first device 1201 can send information in a first device transmission 1232 over the communication link 1230 to the second device 1241. The second device 1241 can send information in a second device transmission 1234 over the communication link 1230 to the first device 1201.

For illustrative purposes, the video coding system 100 is shown with the first device 1201 as a client device, although it is understood that the video coding system 100 can have the first device 1201 as a different type of device. For example, the first device can be a server. In a further example, the first device 1201 can be the video encoder 102, the video decoder 104, or a combination thereof.

Also for illustrative purposes, the video coding system 100 is shown with the second device 1241 as a server, although it is understood that the video coding system 100 can have the second device 1241 as a different type of device. For example, the second device 1241 can be a client device. In a further example, the second device 1241 can be the video encoder 102, the video decoder 104, or a combination thereof.

For brevity of description in this embodiment of the present invention, the first device 1201 will be described as a client device, such as a video camera, smart phone, or a combination thereof. The present invention is not limited to this selection for the type of devices. The selection is an example of the present invention.

The first device 1201 can include a first control unit 1208. The first control unit 1208 can include a first control interface 1214. The first control unit 1208 can execute a first software 1212 to provide the intelligence of the video coding system 100.

The first control unit 1208 can be implemented in a number of different manners. For example, the first control unit 1208 can be a processor, an embedded processor, a microprocessor, a hardware control logic, a hardware finite state machine (FSM), a digital signal processor (DSP), or a combination thereof.

The first control interface 1214 can be used for communication between the first control unit 1208 and other functional units in the first device 1201. The first control interface 1214 can also be used for communication that is external to the first device 1201.

The first control interface 1214 can receive information from the other functional units or from external sources, or can transmit information to the other functional units or to external destinations. The external sources and the external destinations refer to sources and destinations external to the first device 1201.

The first control interface 1214 can be implemented in different ways and can include different implementations depending on which functional units or external units are being interfaced with the first control interface 1214. For example, the first control interface 1214 can be implemented with electrical circuitry, microelectromechanical systems (MEMS), optical circuitry, wireless circuitry, wireline circuitry, or a combination thereof.

The first device 1201 can include a first storage unit 1204. The first storage unit 1204 can store the first software 1212. The first storage unit 1204 can also store the relevant information, such as images, syntax information, video, profiles, display preferences, sensor data, or any combination thereof.

The first storage unit 1204 can be a volatile memory, a nonvolatile memory, an internal memory, an external memory, or a combination thereof. For example, the first storage unit 1204 can be a nonvolatile storage such as non-volatile random access memory (NVRAM), Flash memory, disk storage, or a volatile storage such as static random access memory (SRAM).

The first storage unit 1204 can include a first storage interface 1218. The first storage interface 1218 can be used for communication between the first storage unit 1204 and other functional units in the first device 1201. The first storage interface 1218 can also be used for communication that is external to the first device 1201.

The first device 1201 can include a first imaging unit 1206. The first imaging unit 1206 can capture the video source 108 of FIG. 1 from the real world. The first imaging unit 1206 can include a digital camera, an video camera, an optical sensor, or any combination thereof.

The first imaging unit 1206 can include a first imaging interface 1216. The first imaging interface 1216 can be used for communication between the first imaging unit 1206 and other functional units in the first device 1201.

The first imaging interface 1216 can receive information from the other functional units or from external sources, or can transmit information to the other functional units or to external destinations. The external sources and the external destinations refer to sources and destinations external to the first device 1201.

The first imaging interface 1216 can include different implementations depending on which functional units or external units are being interfaced with the first imaging unit 1206. The first imaging interface 1216 can be implemented with technologies and techniques similar to the implementation of the first control interface 1214.

The first storage interface 1218 can receive information from the other functional units or from external sources, or can transmit information to the other functional units or to external destinations. The external sources and the external destinations refer to sources and destinations external to the first device 1201.

The first storage interface 1218 can include different implementations depending on which functional units or external units are being interfaced with the first storage unit 1204. The first storage interface 1218 can be implemented with technologies and techniques similar to the implementation of the first control interface 1214.

The first device 1201 can include a first communication unit 1210. The first communication unit 1210 can be for enabling external communication to and from the first device 1201. For example, the first communication unit 1210 can permit the first device 1201 to communicate with the second device 1241, an attachment, such as a peripheral device or a computer desktop, and the communication link 1230.

The first communication unit 1210 can also function as a communication hub allowing the first device 1201 to function as part of the communication link 1230 and not limited to be an end point or terminal unit to the communication link 1230. The first communication unit 1210 can include active and passive components, such as microelectronics or an antenna, for interaction with the communication link 1230.

The first communication unit 1210 can include a first communication interface 1220. The first communication interface 1220 can be used for communication between the first communication unit 1210 and other functional units in the first device 1201. The first communication interface 1220 can receive information from the other functional units or can transmit information to the other functional units.

The first communication interface 1220 can include different implementations depending on which functional units are being interfaced with the first communication unit 1210. The first communication interface 1220 can be implemented with technologies and techniques similar to the implementation of the first control interface 1214.

The first device 1201 can include a first user interface 1202. The first user interface 1202 allows a user (not shown) to interface and interact with the first device 1201. The first user interface 1202 can include a first user input (not shown). The first user input can include touch screen, gestures, motion detection, buttons, slicers, knobs, virtual buttons, voice recognition controls, or any combination thereof.

The first user interface 1202 can include the first display interface 120. The first display interface 120 can allow the user to interact with the first user interface 1202. The first display interface 120 can include a display, a video screen, a speaker, or any combination thereof.

The first control unit 1208 can operate with the first user interface 1202 to display video information generated by the video coding system 100 on the first display interface 120. The first control unit 1208 can also execute the first software 1212 for the other functions of the video coding system 100, including receiving video information from the first storage unit 1204 for display on the first display interface 120. The first control unit 1208 can further execute the first software 1212 for interaction with the communication link 1230 via the first communication unit 1210.

For illustrative purposes, the first device 1201 can be partitioned having the first user interface 1202, the first storage unit 1204, the first control unit 1208, and the first communication unit 1210, although it is understood that the first device 1201 can have a different partition. For example, the first software 1212 can be partitioned differently such that some or all of its function can be in the first control unit 1208 and the first communication unit 1210. Also, the first device 1201 can include other functional units not shown in FIG. 1 for clarity.

The video coding system 100 can include the second device 1241. The second device 1241 can be optimized for implementing the present invention in a multiple device embodiment with the first device 1201. The second device 1241 can provide the additional or higher performance processing power compared to the first device 1201.

The second device 1241 can include a second control unit 1248. The second control unit 1248 can include a second control interface 1254. The second control unit 1248 can execute a second software 1252 to provide the intelligence of the video coding system 100.

The second control unit 1248 can be implemented in a number of different manners. For example, the second control unit 1248 can be a processor, an embedded processor, a microprocessor, a hardware control logic, a hardware finite state machine (FSM), a digital signal processor (DSP), or a combination thereof.

The second control interface 1254 can be used for communication between the second control unit 1248 and other functional units in the second device 1241. The second control interface 1254 can also be used for communication that is external to the second device 1241.

The second control interface 1254 can receive information from the other functional units or from external sources, or can transmit information to the other functional units or to external destinations. The external sources and the external destinations refer to sources and destinations external to the second device 1241.

The second control interface 1254 can be implemented in different ways and can include different implementations depending on which functional units or external units are being interfaced with the second control interface 1254. For example, the second control interface 1254 can be implemented with electrical circuitry, microelectromechanical systems (MEMS), optical circuitry, wireless circuitry, wireline circuitry, or a combination thereof.

The second device 1241 can include a second storage unit 1244. The second storage unit 1244 can store the second software 1252. The second storage unit 1244 can also store the relevant information, such as images, syntax information, video, profiles, display preferences, sensor data, or any combination thereof.

The second storage unit 1244 can be a volatile memory, a nonvolatile memory, an internal memory, an external memory, or a combination thereof. For example, the second storage unit 1244 can be a nonvolatile storage such as non-volatile random access memory (NVRAM), Flash memory, disk storage, or a volatile storage such as static random access memory (SRAM).

The second storage unit 1244 can include a second storage interface 1258. The second storage interface 1258 can be used for communication between the second storage unit 1244 and other functional units in the second device 1241. The second storage interface 1258 can also be used for communication that is external to the second device 1241.

The second storage interface 1258 can receive information from the other functional units or from external sources, or can transmit information to the other functional units or to external destinations. The external sources and the external destinations refer to sources and destinations external to the second device 1241.

The second storage interface 1258 can include different implementations depending on which functional units or external units are being interfaced with the second storage unit 1244. The second storage interface 1258 can be implemented with technologies and techniques similar to the implementation of the second control interface 1254.

The second device 1241 can include a second imaging unit 1246. The second imaging unit 1246 can capture the video source 108 from the real world. The first imaging unit 1206 can include a digital camera, an video camera, an optical sensor, or any combination thereof.

The second imaging unit 1246 can include a second imaging interface 1256. The second imaging interface 1256 can be used for communication between the second imaging unit 1246 and other functional units in the second device 1241.

The second imaging interface 1256 can receive information from the other functional units or from external sources, or can transmit information to the other functional units or to external destinations. The external sources and the external destinations refer to sources and destinations external to the second device 1241.

The second imaging interface 1256 can include different implementations depending on which functional units or external units are being interfaced with the second imaging unit 1246. The second imaging interface 1256 can be implemented with technologies and techniques similar to the implementation of the first control interface 1214.

The second device 1241 can include a second communication unit 1250. The second communication unit 1250 can enable external communication to and from the second device 1241. For example, the second communication unit 1250 can permit the second device 1241 to communicate with the first device 1201, an attachment, such as a peripheral device or a computer desktop, and the communication link 1230.

The second communication unit 1250 can also function as a communication hub allowing the second device 1241 to function as part of the communication link 1230 and not limited to be an end point or terminal unit to the communication link 1230. The second communication unit 1250 can include active and passive components, such as microelectronics or an antenna, for interaction with the communication link 1230.

The second communication unit 1250 can include a second communication interface 1260. The second communication interface 1260 can be used for communication between the second communication unit 1250 and other functional units in the second device 1241. The second communication interface 1260 can receive information from the other functional units or can transmit information to the other functional units.

The second communication interface 1260 can include different implementations depending on which functional units are being interfaced with the second communication unit 1250. The second communication interface 1260 can be implemented with technologies and techniques similar to the implementation of the second control interface 1254.

The second device 1241 can include a second user interface 1242. The second user interface 1242 allows a user (not shown) to interface and interact with the second device 1241. The second user interface 1242 can include a second user input (not shown). The second user input can include touch screen, gestures, motion detection, buttons, slicers, knobs, virtual buttons, voice recognition controls, or any combination thereof.

The second user interface 1242 can include a second display interface 1243. The second display interface 1243 can allow the user to interact with the second user interface 1242. The second display interface 1243 can include a display, a video screen, a speaker, or any combination thereof.

The second control unit 1248 can operate with the second user interface 1242 to display information generated by the video coding system 100 on the second display interface 1243. The second control unit 1248 can also execute the second software 1252 for the other functions of the video coding system 100, including receiving display information from the second storage unit 1244 for display on the second display interface 1243. The second control unit 1248 can further execute the second software 1252 for interaction with the communication link 1230 via the second communication unit 1250.

For illustrative purposes, the second device 1241 can be partitioned having the second user interface 1242, the second storage unit 1244, the second control unit 1248, and the second communication unit 1250, although it is understood that the second device 1241 can have a different partition. For example, the second software 1252 can be partitioned differently such that some or all of its function can be in the second control unit 1248 and the second communication unit 1250. Also, the second device 1241 can include other functional units not shown in FIG. 1 for clarity.

The first communication unit 1210 can couple with the communication link 1230 to send information to the second device 1241 in the first device transmission 1232. The second device 1241 can receive information in the second communication unit 1250 from the first device transmission 1232 of the communication link 1230.

The second communication unit 1250 can couple with the communication link 1230 to send video information to the first device 1201 in the second device transmission 1234. The first device 1201 can receive video information in the first communication unit 1210 from the second device transmission 1234 of the communication link 1230. The video coding system 100 can be executed by the first control unit 1208, the second control unit 1248, or a combination thereof.

The functional units in the first device 1201 can work individually and independently of the other functional units. For illustrative purposes, the video coding system 100 is described by operation of the first device 1201. It is understood that the first device 1201 can operate any of the modules and functions of the video coding system 100. For example, the first device 1201 can be described to operate the first control unit 1208.

The functional units in the second device 1241 can work individually and independently of the other functional units. For illustrative purposes, the video coding system 100 can be described by operation of the second device 1241. It is understood that the second device 1241 can operate any of the modules and functions of the video coding system 100. For example, the second device 1241 is described to operate the second control unit 1248.

For illustrative purposes, the video coding system 100 is described by operation of the first device 1201 and the second device 1241. It is understood that the first device 1201 and the second device 1241 can operate any of the modules and functions of the video coding system 100. For example, the first device 1201 is described to operate the first control unit 1208, although it is understood that the second device 1241 can also operate the first control unit 1208.

The physical transformation from the images of physical objects of the video source 108 to displaying the video stream 112 on the pixel elements of the display interface 120 of FIG. 1 results in physical changes to the pixel elements of the display interface 120 in the physical world, such as the change of electrical state the pixel element, is based on the operation of the video coding system 100. As the changes in the physical world occurs, such as the motion of the objects captured in the video source 108, the movement itself creates additional information, such as the updates to the video source 108, that are converted back into changes in the pixel elements of the display interface 120 for continued operation of the video coding system 100.

The first software 1212 of FIG. 9 of the first device 1201 can include the video coding system 100. For example, the first software 1212 can include the receive bitstream module 804, the detect filter flag module 806, the default filter module 808, the adaptive filter module 810, and the upsampling filter module 812.

The first control unit 1208 of FIG. 9 can execute the first software 1212 for the receive bitstream module 804 to receive the video bitstream 110. The first control unit 1208 can execute the first software 1212 for the detect filter flag module 806 to determine which filter module to use. The first control unit 1208 can execute the first software 1212 for the default filter module 808 to select and assign one of the default filters 704 to the upsampling filter 531 and assign one of the default filter coefficients 708 to the upsampling filter coefficients 702. The first control unit 1208 can execute the first software 1212 for the adaptive filter module 810 to assign the adaptive filter to the upsampling filter 531 and assign the adaptive filter coefficients 208 to the upsampling filter coefficients 702. The first control unit 1208 can execute the first software 1212 for the upsampling filter module 812 to form the enhancement layers 124.

The second software 1252 of FIG. 9 of the second device 1241 of FIG. 1 can include the video coding system 100. For example, the second software 1252 can include the receive bitstream module 804, the detect filter flag module 806, the default filter module 808, the adaptive filter module 810, and the upsampling filter module 812.

The second control unit 1248 of FIG. 9 can execute the second software 1252 for the receive bitstream module 804 to receive the video bitstream 110. The second control unit 1248 can execute the second software 1252 for the detect filter flag module 806 to determine which filter module to use. The second control unit 1248 can execute the second software 1252 for the default filter module 808 to select and assign one of the default filters 704 to the upsampling filter 531 and assign one of the default filter coefficients 708 to the upsampling filter coefficients 702. The second control unit 1248 can execute the second software 1252 for the adaptive filter module 810 to assign the adaptive filter to the upsampling filter 531 and assign the adaptive filter coefficients 208 to the upsampling filter coefficients 702. The second control unit 1248 can execute the second software 1252 for the upsampling filter module 812 to form the enhancement layers 124.

The video coding system 100 can be partitioned between the first software 1212 and the second software 1252. For example, the second software 1252 can include the default filter module 808, the adaptive filter module 810, and the upsampling filter module 812. The second control unit 1248 can execute modules partitioned on the second software 1252 as previously described.

In an illustrative example, the video coding system 100 can include the video encoder 102 on the first device 1201 and the video decoder 104 on the second device 1241. The video decoder 104 can include the display processor 118 of FIG. 1 and the display interface 120.

The first software 1212 can include the receive bitstream module 804 and the detect filter flag module 806. Depending on the size of the first storage unit 1204 of FIG. 9, the first software 1212 can include additional modules of the video coding system 100. The first control unit 1208 can execute the modules partitioned on the first software 1212 as previously described.

The first control unit 1208 can operate the first communication unit 1210 of FIG. 9 to send the video bitstream 110 to the second device 1241. The first control unit 1208 can operate the first software 1212 to operate the first imaging unit 1206 of FIG. 9. The second communication unit 1250 of FIG. 9 can send the video stream 112 to the first device 1201 over the communication link 1230.

The video coding system 100 describes the module functions or order as an example. The modules can be partitioned differently. For example, the default filter module 808 and the adaptive filter module 810 can be combined. Each of the modules can operate individually and independently of the other modules.

Furthermore, data generated in one module can be used by another module without being directly coupled to each other. For example, the upsampling filter module 812 can receive the assignment of the upsampling filter 531 and the upsampling filter coefficients 702 from the default filter module 808 or the adaptive filter module 810.

The modules can be implemented in a variety of ways. The receive bitstream module 804, the detect filter flag module 806, the default filter module 808, the adaptive filter module 810, and the upsampling filter module 812 can be implemented in as hardware accelerators (not shown) within the first control unit 1208 or the second control unit 1248, or can be implemented in as hardware accelerators (not shown) in the first device 1201 or the second device 1241 outside of the first control unit 1208 or the second control unit 1248.

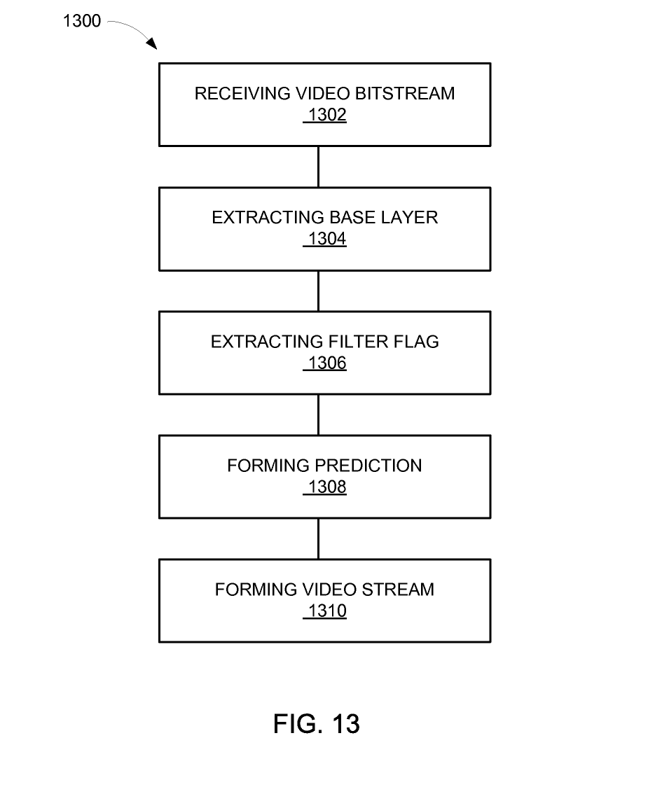

Referring now to FIG. 13, therein is shown a flow chart of a method 1300 of operation of the video coding system in a further embodiment of the present invention. The method 1300 includes: receiving a video bitstream in a block 1302; extracting a base layer from the video bitstream in a block 1304; extracting a filter flag from the video bitstream in a block 1306; forming a prediction for calculating an enhancement layer by upsampling the base layer using an upsampling filter, the upsampling filter configured with upsampling filter coefficients in a block 1308; and forming a video stream based on the base layer, the enhancement layer, and the filter flag for displaying on a device in a block 1310.

It has been discovered that the present invention thus has numerous aspects. The present invention valuably supports and services the historical trend of reducing costs, simplifying systems, and increasing performance. These and other valuable aspects of the present invention consequently further the state of the technology to at least the next level.

Thus, it has been discovered that the video coding system of the present invention furnishes important and heretofore unknown and unavailable solutions, capabilities, and functional aspects for efficiently coding and decoding video content. The resulting processes and configurations are straightforward, cost-effective, uncomplicated, highly versatile and effective, can be surprisingly and unobviously implemented by adapting known technologies, and are thus readily suited for efficiently and economically manufacturing video coding devices fully compatible with conventional manufacturing processes and technologies.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a video coding system comprising:
receiving a video bitstream;
extracting a base layer from the video bitstream;
extracting a filter flag from the video bitstream;
forming a prediction for calculating an enhancement layer by upsampling the base layer using an upsampling filter, the upsampling filter configured with upsampling filter coefficients; and
forming a video stream based on the base layer, the enhancement layer, and the filter flag for displaying on a device.

2. The method as claimed in claim 1 further comprising:
extracting adaptive filter coefficients from the video bitstream based on the filter flag; and
wherein:
setting the upsampling filter coefficients to the adaptive filter coefficients.

3. The method as claimed in claim 1 further comprising:
extracting a filter index from the video bitstream; and
wherein:
assigning a default filter for the upsampling filter based on the filter index for forming the enhancement layer.

4. The method as claimed in claim 1 further comprising:
extracting a filter index from the video bitstream; and
wherein:
setting the upsampling filter coefficients to a default filter coefficients based on the on the filter index and the filter flag for forming the enhancement layer.

5. The method as claimed in claim 1 wherein forming the prediction includes setting the upsampling filter coefficients to the default filter coefficients based on the filter flag.

6. A method of operation of a video coding system comprising:
receiving a video bitstream;
extracting a base layer from the video bitstream;
extracting a parameter set from the video bitstream;
extracting a filter flag from the parameter set;
configuring an upsampling filter with upsampling filter coefficients based on the filter flag;
forming a prediction for calculating an enhancement layer by upsampling the base layer using the upsampling filter, the upsampling filter configured with the upsampling filter coefficients; and
forming a video stream based on the base layer, of the enhancement layer, and the filter flag for displaying on a device.

7. The method as claimed in claim 6 further comprising:
extracting adaptive filter coefficients from the video bitstream based on the filter flag; and
wherein:
setting the upsampling filter coefficients to the adaptive filter coefficients.

8. The method as claimed in claim 6 further comprising:
extracting a filter index from the video bitstream; and
selecting a default filter for the upsampling filter based on the filter index for forming the enhancement layer.

9. The method as claimed in claim 6 further comprising:
extracting a filter index from the video bitstream; and
wherein:
setting the upsampling filter coefficients to a default filter coefficients based on the on the filter index and the filter flag for forming the enhancement layer.

10. The method as claimed in claim 6 wherein forming the prediction includes setting the upsampling filter coefficients to default filter coefficients based on the filter flag.

11. A video coding system comprising:
a receive bitstream module for receiving a video bitstream and extracting a filter flag from the video bitstream;
an upsampling filter module, coupled to the receive bitstream module, for extracting a base layer from the video bitstream, and for forming a prediction for calculating an enhancement layer by upsampling the base layer using an upsampling filter, the upsampling filter configured with upsampling filter coefficients; and
a display interface, coupled to the upsampling filter module, for forming a video stream based on the base layer, the enhancement layer, and the filter flag for displaying on a device.

12. The system as claimed in claim 11 wherein:
the receive bitstream module is for extracting adaptive filter coefficients from the video bitstream based on the filter flag; and
further comprising:
an adaptive filter module, coupled to the upsampling filter module, for setting the upsampling filter coefficients to the adaptive filter coefficients.

13. The system as claimed in claim 11 wherein:
the receive bitstream module is for extracting a filter index from the video bitstream; and
further comprising:
a default filter module, coupled to the receive bitstream module, for assigning a default filter for the upsampling filter based on the filter index for forming the enhancement layer.

14. The system as claimed in claim 11 wherein:
the receive bitstream module is for extracting a filter index from the video bitstream; and
further comprising:
a default filter module, coupled to the receive bitstream module, for setting the upsampling filter coefficients to the default filter coefficients based on the on the filter index and the filter flag for forming the enhancement layer.

15. The system as claimed in claim 11 further comprising:
a default filter module, coupled to the receive bitstream module, for setting the upsampling filter coefficients a default filter coefficients based on the filter flag.

16. The system as claimed in claim 11 wherein:
a default filter module is for extracting the base layer from the video bitstream, extracting a parameter set from the video bitstream, and extracting the filter flag from the parameter set; and
the upsampling filter module is for forming the prediction for calculating the enhancement layer from the base layer using the upsampling filter.

17. The system as claimed in claim 16 wherein:
the receive bitstream module is for extracting adaptive filter coefficients from the video bitstream based on the filter flag; and
further comprising:
an adaptive filter module, coupled to the upsampling filter module, for setting the upsampling filter coefficients to the adaptive filter coefficients.

18. The system as claimed in claim 16 wherein:
the receive bitstream module is for extracting a filter index from the video bitstream; and
further comprising:
the default filter module, coupled to the receive bitstream module, for selecting a default filter for the upsampling filter based on the filter index for forming the enhancement layer.

19. The system as claimed in claim 16 wherein:
the receive bitstream module is for extracting a filter index from the video bitstream; and
further comprising:
the default filter module, coupled to the receive bitstream module, for setting the upsampling filter coefficients to a default filter coefficients based on the on the filter index and the filter flag for forming the enhancement layer.

20. The system as claimed in claim 16 further comprising the default filter module, coupled to the receive bitstream module, for setting the upsampling filter coefficients to default filter coefficients based on the filter flag.
